(19) United States
(12) Patent Application Publication
(10) Pub. No.: US 2009/0001952 A1
(43) Pub. Date: Jan. 1, 2009

(54) Apparatus and method for improving a transient response of a power converter

(76) Inventors: Wei-Hsu Chang, Jubei City (TW); Jing-Meng Liu, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,636

(22) Filed: Aug. 3, 2007

(30) Foreign Application Priority Data
Jun. 29, 2007 (TW) 096123786

(51) Int. Cl. G05F 1/00

(52) U.S. Cl. 323/280

(57) ABSTRACT

The output current of a power converter is sensed for triggering a quick transient response when the variation of the output current reaches a default value, and therefore the output voltage of the power converter is promptly stabilized earlier by removing the time delay to trigger the quick transient response.

### FIELD OF THE INVENTION

The present invention is related generally to power converters and, more particularly, to a transient response improvement of a power converter.

### BACKGROUND OF THE INVENTION

Power converters have been widely applied to various electronic products for providing a stable supply voltage to a load. FIG. 1 shows a conventional single-phase voltage mode power converter 100, in which a controller 104 generates a control signal PWM to drive an output stage 102 so as to provide an output voltage Vo and an output current Io for a load Ro. In the output stage 102, a driver 106 switches serially connected switching transistors M1 and M2 according to the control signal PWM so as to produce an inductor current IL flowing through an inductor L to charge a capacitor C in order to generate the output voltage Vo. The capacitor C also filters the inductor current IL to generate the output current Io. In the controller 104, a feedback circuit 114 generates a feedback signal VFB according to the output voltage Vo, an error amplifier 112 compares the feedback signal VFB with a reference voltage Vref to determine an error signal VCOMP, and a comparator 108 compares the error signal VCOMP with a ramp signal Vramp from a ramp generator 110 so as to generate the control signal PWM. The control signal PWM is a pulse width modulation signal which determines the switching frequency and the duty cycle of the switching transistors M1 and M2.

FIG. 2 shows a conventional single-phase current mode power converter 200, in which an output stage 202 is operative with a control signal PWM to provide an output current Io and an output voltage Vo for a load Ro, and a controller 204 modulates a duty cycle of the control signal PWM by monitoring an inductor current IL in the output stage 202 and the output voltage Vo. In the output stage 202, a driver 206 switches serially connected switching transistors M1 and M2 according to the control signal PWM so as to produce the inductor current IL flowing through an inductor L and a current sensing resistor Rs, to charge a capacitor C in order to generate the output voltage Vo. In the controller 204, a feedback circuit 216 generates a feedback signal VFB according to the output voltage Vo, an error amplifier 214 compares the feedback signal VFB with a reference voltage Vref to determine an error signal VCOMP, a current sensing amplifier 210 senses the inductor current IL from the current sensing resistor Rs to produce a current sensing signal ISENSE, a combiner 209 adds the current sensing signal ISENSE and a ramp signal Vramp from a ramp generator 212 to produce a signal SUM, and a comparator 208 compares the signal SUM with the error signal VCOMP to generate the control signal PWM. The control signal PWM is a pulse width modulation signal which determines the switching frequency and the duty cycle of the switching transistors M1 and M2.

In either the power converter 100 or 200, the load current dynamic response is determined by the loop-gain of the power converter. Typically, the bandwidth thereof is one tenth of that of the switching frequency of the switching transistors M1 and M2. To improve the load current dynamic response, a non-linear quick transient response, also known as a quick-response, is addressed. FIG. 3 shows a conventional single-phase voltage mode power converter 300 having a function of quick transient response, in which an output stage 102 provides an output current Io and an output voltage Vo for a load Ro, a controller 104 detects the output voltage Vo to generate a control signal PWM to drive the output stage 102, and a quick-response detector 306 detects the output voltage Vo to perform a quick transient response. When a load current transient occurs, the output voltage Vo will change accordingly. If the quick-response detector 306 detects that the output voltage Vo is lower than a default value TQR, the quick-response detector 306 signals the controller 104 by a quick response signal QR to change the duty cycle or the switching frequency of the control signal PWM, and in turn change the duty cycle or the switching frequency of the switching transistors M1 and M2, such that the violating output voltage Vo can be promptly stabilized. In the quick-response detector 306, a comparator 318 compares the output voltage Vo with the default value VQR, and when the output voltage Vo is lower than the default value VQR, the comparator 318 triggers the quick response signal QR to change the duty cycle or the switching frequency of the control signal PWM by some way, for example, changing the oscillating frequency of the ramp signal Vramp to change the switching frequency of the control signal PWM, or changing the level of the error signal VCOMP to change the duty cycle of the control signal PWM.

FIG. 4 shows a conventional single-phase current mode power converter 400 having a function of quick transient response, in which a controller 204 provides a control signal PWM to drive an output stage 202 to generate an output current Io and an output voltage Vo, and a quick-response detector 406 detects the output voltage Vo to perform a quick transient response. When a load current transient occurs, if it is detected that the output voltage Vo is lower than a default value VQR, the quick-response detector 406 signals the controller 204 by a quick response signal QR to change the duty cycle or the switching frequency of the control signal PWM, such that the violating output voltage Vo can be promptly stabilized. In the quick-response detector 406, a comparator 422 compares the output voltage Vo with the default value VQR to trigger the quick response signal QR. When a load current transient occurs, the output voltage Vo changes, and if the output voltage Vo is lower than the default value VQR, prompted by the quick response signal QR, the controller 404 will change the level of the error signal VCOMP or the oscillating frequency of the ramp signal Vramp, and in turn change the duty cycle or the switching frequency of the switching transistors M1 and M2.

FIG. 5 is a waveform diagram showing the varying signals of either the power converter 300 or 400 during a load current transient, in which waveform 500 represents the control signal PWM, waveform 502 represents the inductor current IL, waveform 504 represents the output current Io, and waveform 506 represents the output voltage Vo. A load (current transient appears at time t1, and at this time, the output current Io begins to increase and the output voltage Vo still remains constant for a time period Td_Vo because the capacitor C keeps providing charges to the load Ro. At time t2, the charges stored on the capacitor C is not sufficient to provide the current that the load Ro needs, and therefore the output voltage Vo begins to decrease. Until time t3, the output voltage Vo begins to increase again. The capacitance and the parasitic resistor of the capacitor C determine where the output voltage Vo will drop to and how long of the delay time Ts_Vo for the output voltage Vo to begin to recover. As shown in FIG. 5, the conventional quick transient response is carried out by sensing the output voltage Vo and therefore, delays caused by the times Td_Vo and Ts_Vo happened to the sensing process can retard the quick transient response mechanism.

Hence, it is desired an improvement to the quick transient response of a power converter.

### SUMMARY OF THE INVENTION

Accordingly, it is an object of the present invention to provide an apparatus and a method that realize a quick transient response for a power converter by sensing an output current of the power converter.

For a power converter which has an output stage for providing an output current and an output voltage for a load and a controller for providing a control signal to drive the output stage, according to the present invention, a current sensing circuit is provided to sense the output current so as to determine a current sensing signal, and a quick-response detector triggers a quick transient response if the current sensing signal rising up to or over a default value, such that the controller will change the switching frequency or the duty cycle of the output stage.

### BRIEF DESCRIPTION OF THE DRAWINGS

The present invention can be more fully understood by reading the subsequent detailed description and embodiments with references made to the accompanying drawings, wherein:

FIG. 1 shows a conventional single-phase voltage mode power converter;

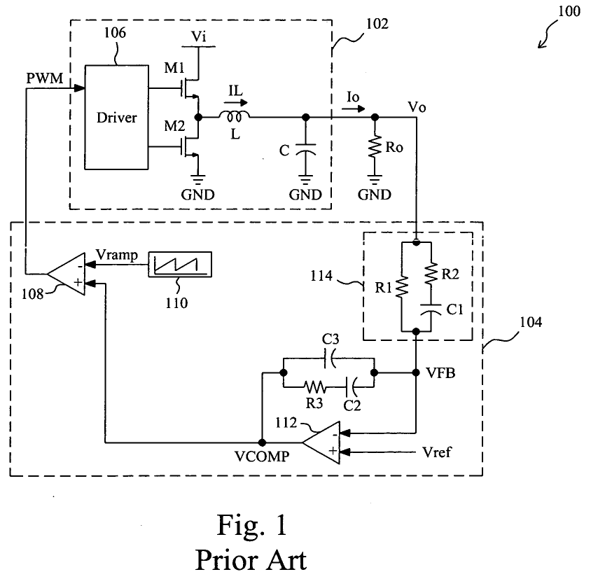

FIG. 2 shows a conventional single-phase current mode power converter;

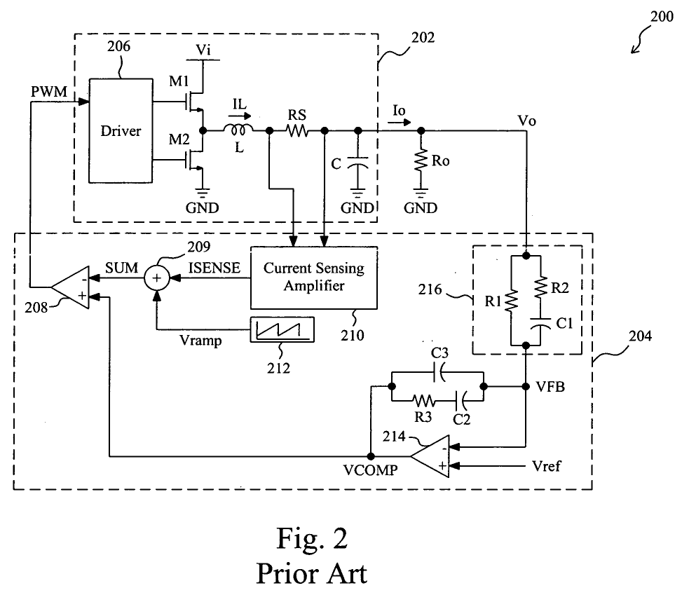

FIG. 3 shows a conventional single-phase voltage mode power converter having a function of quick transient response;

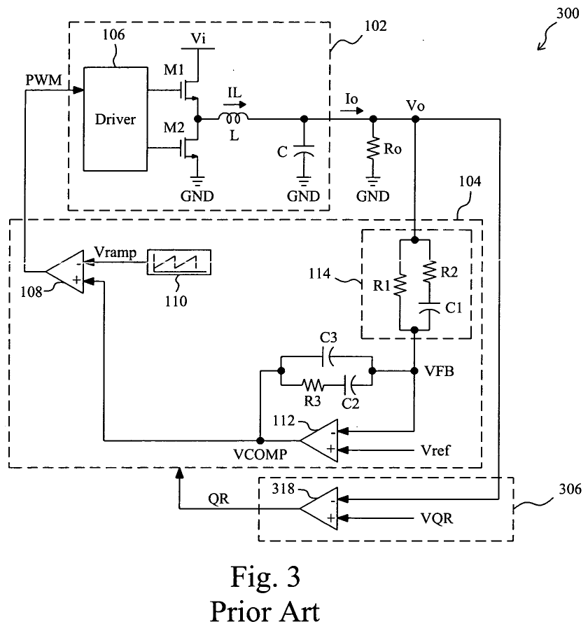

FIG. 4 shows a conventional single-phase current mode power converter having a function of quick transient response;

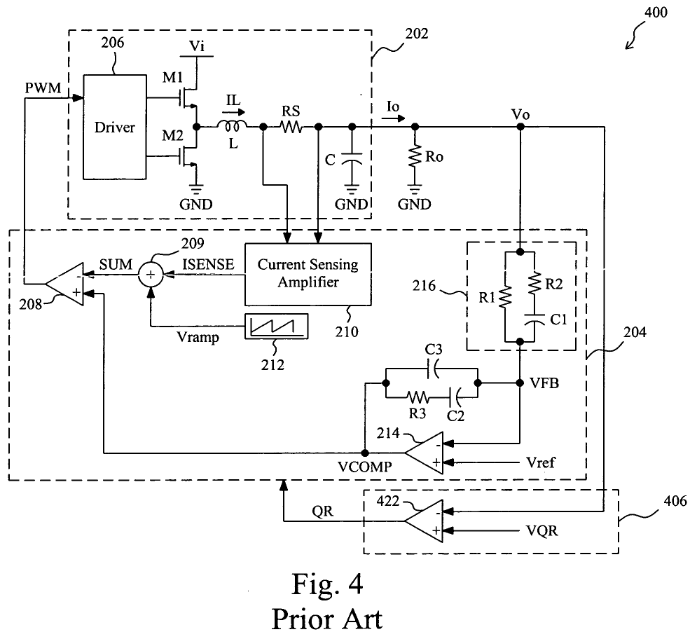

FIG. 5 is a waveform diagram showing the varying signals of either the power converter of FIG. 3 or FIG. 4 during a load current transient;

FIG. 6 provides an embodiment according to the present invention;

FIG. 7 is a waveform diagram showing the varying signals of the power converter of FIG. 6 during a load current transient;

FIG. 8 shows a first embodiment for the current sensing circuit of FIG. 6;

FIG. 9 shows a second embodiment for the current sensing circuit of FIG. 6; and

FIG. 10 shows a third embodiment for the current sensing circuit of FIG. 6.

### DETAIL DESCRIPTION OF THE INVENTION

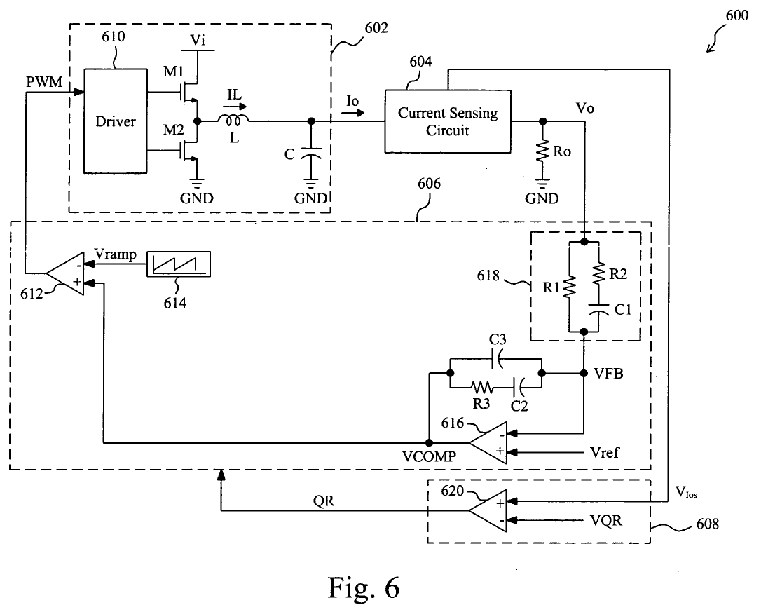

FIG. 6 provides an embodiment according to the present invention. In a single-phase voltage mode power converter 600, a controller 606 provides a control signal PWM to drive an output stage 602 so as to generate an output voltage Vo and an output current Io for a load Ro, a current sensing circuit 604 senses the output current Io to generate a current sensing signal V_{Ios}, and a quick-response detector 608 triggers a quick transient response when the current sensing signal V_{Ios} is detected to rise up to or over a default value VQR. In the output stage 602, a driver 610 switches serially connected switching transistors M1 and M2 with the switching frequency and the duty cycle determined by the control signal PWM, and an inductor current IL is produced to flow through an inductor L to charge a capacitor C so as to generate the output voltage Vo. In the controller 606, a feedback circuit 618 generates a feedback signal VFB from the output voltage Vo, an error amplifier 616 compares the feedback signal VFB with a reference voltage Vref to generate an error signal VCOMP, a ramp generator 614 provides a ramp signal Vramp, and a comparator 612 generates the control signal PWM by comparing the error signal VCOMP and the ramp signal Vramp. The quick-response detector 608 comprises a comparator 620 for comparing the current sensing signal V_{Ios} with the default value VQR to determine a quick response signal VQR. When the current sensing signal V_{Ios} rises up to reach or over the default value VQR, the quick response signal QR will signal the controller 606 to perform a quick transient response, during which the duty cycle or the switching frequency of the control signal PWM will change and therefore, the duty cycle or the switching frequencies of the switching transistors M1 and M2 will change accordingly. The method for changing the duty cycle or the switching frequency of the control signal PWM may include changing the level of the error signal VCOMP so as to change the duty cycle of the control signal PWM, or changing the oscillating frequency of the ramp signal Vramp so as to change the switching frequency of the control signal PWM.

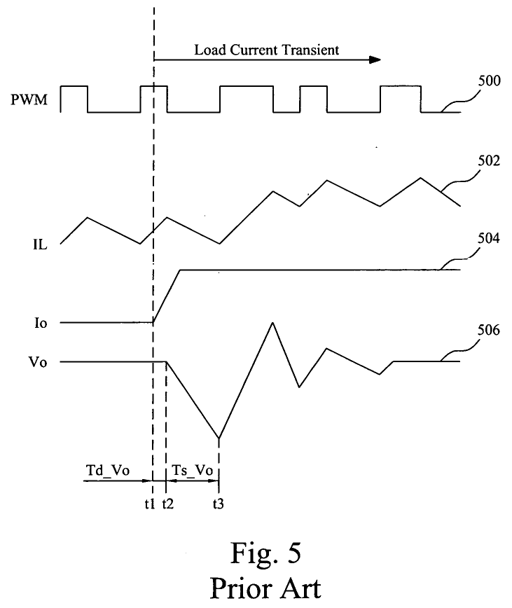

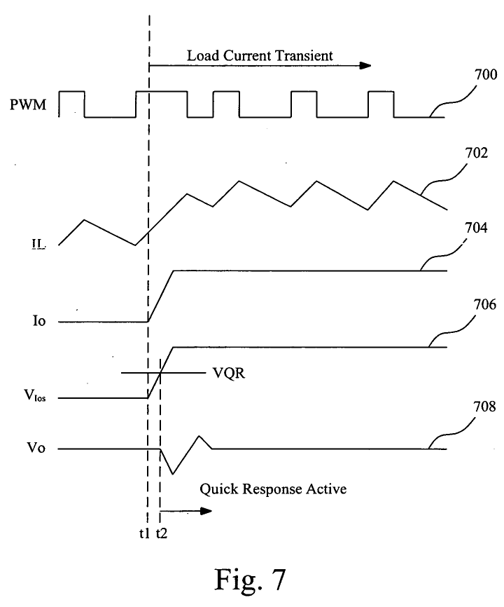

FIG. 7 is a waveform diagram showing the varying signals of the power converter 600 during a load current transient, in which waveform 700 represents the control signal PWM, waveform 702 represents the inductor current IL, waveform 704 represents the output current Io, waveform 706 represents the current sensing signal V_{Ios}, and waveform 708, represents the output voltage Vo. When a load current transient occurs to the power converter 600 at time t1 and makes the output current Io increase, the current sensing signal V_{Ios} rises up correspondingly. When the current sensing signal V_{Ios} reaches the default value VQR at time t2, a quick transient response is triggered so as to stabilize the output voltage Vo. Comparing FIGS. 5 and 7, the conventional method implemented by sensing the output voltage Vo can only trigger the quick transient response when the variation of the output voltage Vo reaches a predetermined level, whereas in the method according to the present invention, by sensing the output current Io, the quick transient response can be triggered before the variation of the output voltage Vo reaches the predetermined level or even before the output voltage varies. Hence, the method according to the present invention can speed up the power converter to respond to the variation of the load current Io.

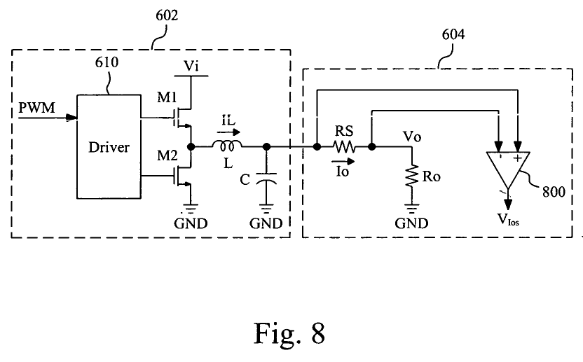

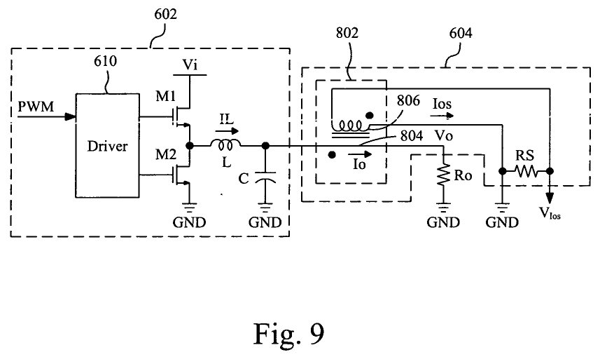

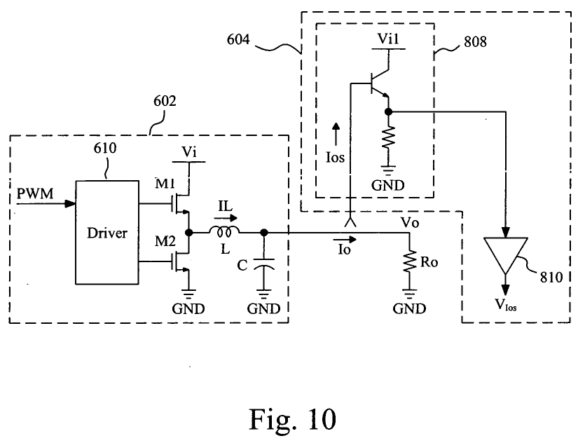

FIG. 8 provides a first embodiment for the current sensing circuit 604 of FIG. 6, which comprises a current sensing resistor Rs serially connected to the load Ro, and an operational amplifier 800 for sensing the output current lo by detecting the voltage across the current sensing resistor Rs, so as to generate the current sensing signal V_{Ios}. FIG. 9 provides a second embodiment for the current sensing circuit 604 of FIG. 6, which comprises a transformer 802 and a resistor Rs. The transformer 802 has a primary coil 804 serially connected to the load Ro such that the output current Io flows therethrough, and a secondary coil 806 to induce a secondary current Ios from the primary current Io in the primary coil 804. The secondary current Ios flows through the resistor Rs for generating the current sensing signal V_{Ios}. As shown in FIG. 9, the primary coil 804 may be constructed from the discrete inductor in the circuit. FIG. 10 provides a third embodiment for the current sensing circuit 604 of FIG. 6, which comprises a Hall sensor 808 for deriving an induced current Ios by sensing the output current lo to generate the current sensing signal V_{Ios} through a buffer 810 to the quick-response detector 608. The buffer 810 functions for avoiding impedance mismatch.

Since the present invention realizes a quick transient response by sensing the output current Io, the delay resulted form Td_Vo and Ts_Vo can be eliminated in the sensing process. Though only single-phase voltage mode power converters are described for the purpose of illustration, it is noted that the present invention can be also applied to power converters of various other types such as multi-phase power converters, current mode power converters and etc.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An apparatus for improving a transient response of a power converter which has an output stage for providing an output current and an output voltage for a load and a controller for providing a control signal to drive the output stage, the control signal determining a switching frequency and a duty cycle for the output stage, the apparatus comprising:
a current sensing circuit for sensing the output current to determine a current sensing signal; and
a quick-response detector for triggering a quick transient response for the power converter if the current sensing signal rising up to or over a default value, so as to stabilize the output voltage.

2. The apparatus of claim 1, wherein the current sensing circuit comprises:
a resistor serially connected to the load; and
an operational amplifier for generating the current sensing signal according to a voltage across the resistor.

3. The apparatus of claim 1, wherein the current sensing circuit comprises:
a resistor; and
a transformer having a primary coil connected between the output stage and the load and a secondary coil connected to the resistor, for transforming a primary current in the primary coil to a secondary current in the secondary coil to further flow through the resistor, so as to generate the current sensing signal from a voltage across the resistor.

4. The apparatus of claim 1, wherein the current sensing circuit comprises a Hall sensor for sensing the output current so as to generate the current sensing signal.

5. The apparatus of claim 4, wherein the current sensing circuit further comprises a buffer connected between the Hall sensor and the quick-response detector.

6. The apparatus of claim 1, wherein the quick-response detector comprises a comparator for comparing the current sensing signal with the default value.

7. The apparatus of claim 1, wherein the quick-response detector changes the switching frequency during the quick transient response.

8. The apparatus of claim 1, wherein the quick-response detector changes the duty cycle during the quick transient response.

9. A method for improving a transient response of a power converter which is operative with a switching frequency and a duty cycle to provide an output current and an output voltage for a load, the method comprising the steps of:
monitoring the output current;
triggering a quick transient response if an output current transient is detected; and
stabilizing the output voltage by the quick transient response.

10. The method of claim 9, wherein the step of monitoring the output current comprises the step of generating a current sensing signal which is proportional to the output current.

11. The method of claim 10, wherein the step of triggering a quick transient response if an output current transient is detected comprises the step of comparing the current sensing signal with a default value.

12. The method of claim 9, wherein the step of stabilizing the output voltage by the quick transient response comprises the step of changing the switching frequency.

13. The method of claim 9, wherein the step of stabilizing the output voltage by the quick transient response comprises the step of changing the duty cycle.
